(19) United States
(12) Patent Application Publication
(10) Pub. No.: US 2003/0061749 A1
(43) Pub. Date: Apr. 3, 2003

(54) Bumper buddy : parking decal plate by chris bryant

(76) Inventor: Christopher William Bryant, Hamptom, VA (US)

Correspondence Address: CHRIS BRYANT, 5547 CHAPMANS LANDING RD, INDIAN HEAD, MD, 20640, US

(21) Appl. No.: 09/870,573

(22) Filed: Sep. 29, 2001

(51) Int. Cl. G09F 21/04; G09F 7/00

(52) U.S. Cl. 40/591; 40/210

(57) ABSTRACT

I Christopher William Bryant of Indian Head, Md. have invented a device called the “Bumper Buddy”. The reason for the name “Bumper Buddy” is because it helps protect the bumper of your Automobile from unsightly, hard to remove parking lot stickers or decals. This new device attaches to the license plate of a car and you can apply parking lot stickers, business, school and military decals to this device without having to attach them to your automobile's bumper. The “Bumper Buddy” is a small aluminum or plastic plate that is attached to the two bottom holes of the license plate of a car. The “Bumper Buddy” is available as a blank plate or a logo or name can be printed on the plate.

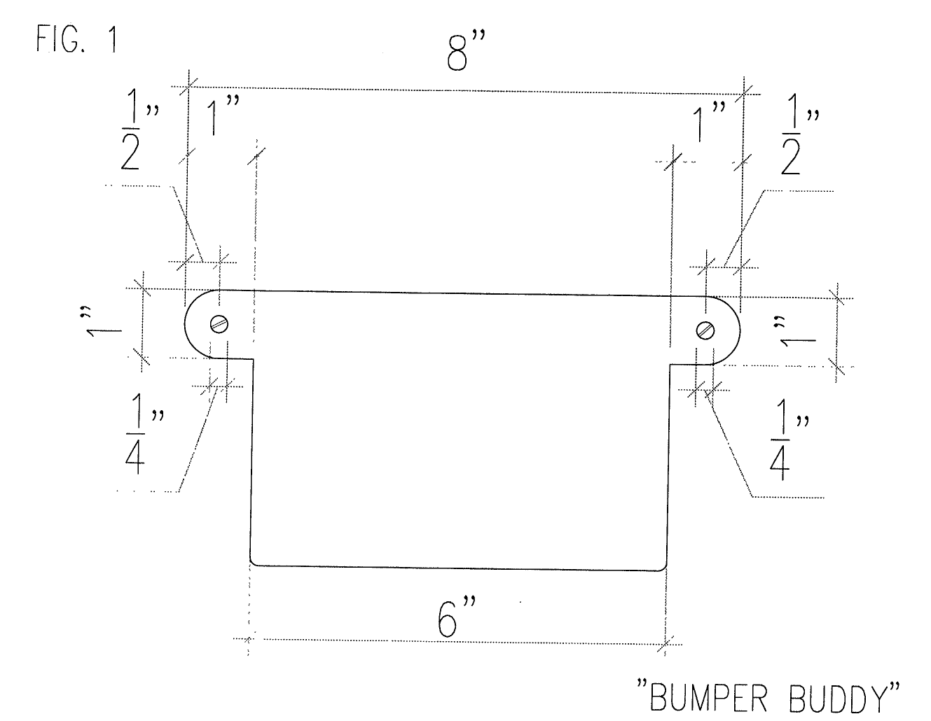

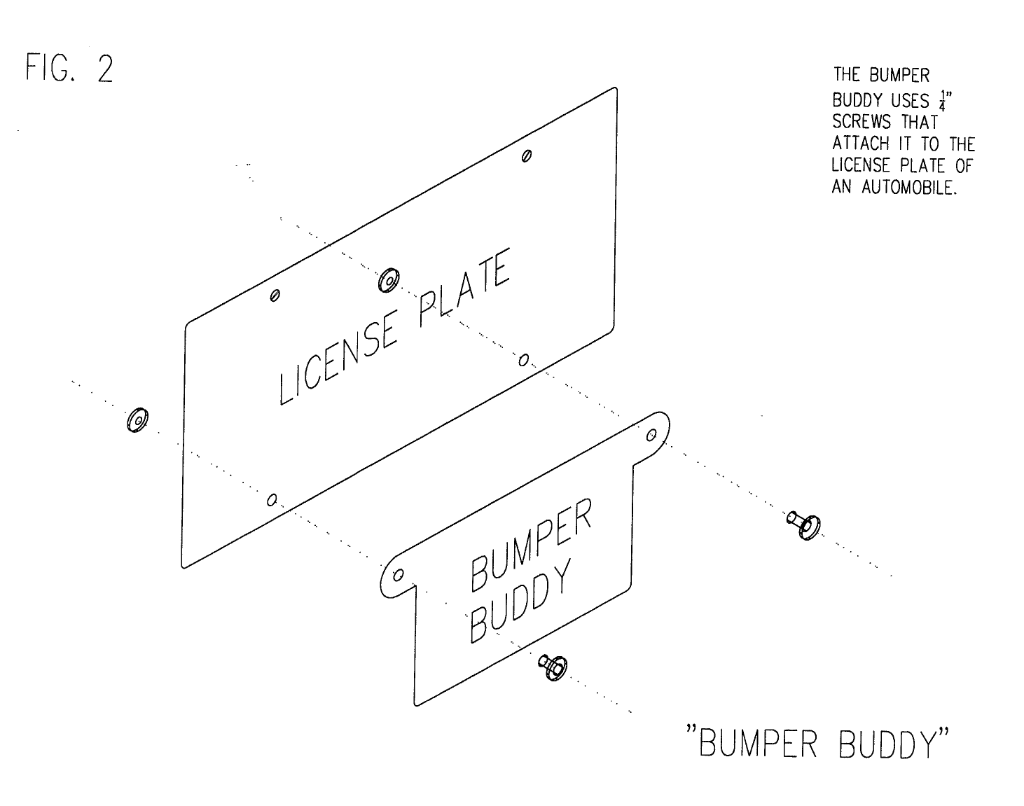

I Christopher William Bryant of Indian Head, Md. have invented a new and useful device that attaches to the license plate of a car and you can attach parking lot stickers, business, school, military decals to this device without having to attach them to your car bumper, this device is called the “Bumper Buddy.”

The reason for its name is because it helps protect the bumper of your car from unsightly hard to remove stickers. At my last job, we received new parking lot stickers for our cars every month. After the 1^{st} year at my job, my car bumper looked like an advertisement billboard. I tried to scrape off the old stickers with a razor. After cut fingers and scratched paint on my bumper, I unsuccessfully tried to wipe off the marks from the sticker adhesive. I thought, “There has got to be a better way!” So knowing that necessity is the mother of invention, I invented the “Bumper Buddy” parking decal plate.

The “Bumper Buddy” parking decal plate is a small 8″×3″ T-shaped aluminum or plastic plate that is attached to the two bottom holes of the license plate of a car. The “Bumper Buddy” is available as a blank plate or a logo of a business, school or a team can be screen printed on the plate. The “Bumper Buddy” is easy to install. First, in the front space provided on the plate you attach your desired decal. Then, using screws, you just attach the plate by screwing it into the existing bottom holes of your license plate and you are done, it is that simple. When you get a new decal or sticker either peal off the old decal, place the new one over the old or replace it with a new “Bumper Buddy”. No more unsightly stickers or decals attached to your bumper because you can attach them to your “Bumper Buddy”.

1. I claim that the “Bumper Buddy” parking decal plate is a small 8″×3″ aluminum or plastic plate. The “Bumper Buddy” can be attached to the bottom two holes on the license plate of a car. The “Bumper Buddy” allows car owners to display their parking permit, business, favorite team, school or personal decals. The “Bumper Buddy” avoids the placement of the adhesive decal on the bumper of their car.
